(19) United States
(12) Patent Application Publication
(10) Pub. No.: US 2007/0170027 A1
(43) Pub. Date: Jul. 26, 2007

(54) PISTON LOAD OF VEHICLE HEIGHT ADJUSTING SHOCK ABSORBER AND METHOD OF MACHINING THE SAME

(75) Inventor: Hak Kyu Kim, Iksan-si (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Mando Corporation, Seoul (KR)

(21) Appl. No.: 11/621,492

(22) Filed: Jan. 9, 2007

(30) Foreign Application Priority Data
Jan. 20, 2006 (KR) 10-2006-0006194

(51) Int. Cl. F16F 9/00

(52) U.S. Cl. 188/321.11

(57) ABSTRACT

A piston rod installed to a vehicle height adjusting shock absorber includes a body portion having a hollow portion, the hollow portion having first and second ends that are opened. A catching portion is formed to be spaced apart by a predetermined distance inwardly from the first end of the hollow portion. A guide member is inserted into the hollow portion from the second end to plug the open hollow portion, the guide member being secured to the catching portion for the movement of the guide member to be constrained.

### BACKGROUND OF THE INVENTION

The present invention relates to a piston rod of a vehicle height adjusting shock absorber, and more particularly, to a method of manufacturing the hollow section of the piston rod to increase the accuracy and smoothness of the hole and increase the ease of cleaning out burrs and chips from the machined hole.

In general, a vehicle is equipped with shock absorbers for improving the ride comfort during driving conditions by absorbing shocks or vibrations transferred from the road to the axle. The shock absorber is installed between an axle and the vehicle body, and the interior thereof is filled with gas or oil in order to increase damping force.

In addition to absorbing shocks to the vehicle, some shock absorbers provide the ability to keep the height of the vehicle constant regardless of the number of passengers or the baggage weight loaded. Such a shock absorber is classified as a vehicle height adjusting shock absorber.

A conventional vehicle height adjusting shock absorber includes a base shell, an inner tube installed inside the base shell, a blade, and an outer tube. The blade and the outer tube are longitudinally installed between the base shell and the inner tube. A piston rod is also installed in the inner tube, and the other end of the piston rod has an upper eye, which attaches to the vehicle body.

FIG. 1 is a sectional view of a part of a conventional piston rod, and FIG. 2 is a sectional view showing the upper eye separated from the piston rod.

As shown in FIGS. 1 and 2, in a conventional piston rod 10, a coupling recess portion 12 to be coupled with an upper eye 20 is formed in an upper end of the piston rod 10. A thread 12a is machined on an inner surface of the coupling recess portion 12. In addition, the piston rod 10 is formed with a hollow portion 14 into which a pump tube is to be inserted. Meanwhile, the upper eye 20 includes a ring portion 22 and a coupling portion 24 integrally formed with the ring portion 22. The ring portion 22 includes inner and outer rings 22a, 22b to be coupled with the vehicle body. The coupling portion 24 is coupled to the coupling recess portion 12 of the piston rod 10. The coupling portion 24 is formed with a thread 24a configured to be engaged with the thread 12a formed in the coupling recess portion 12.

The piston rod 10 is made of a solid rod, in which the hollow portion 14 and coupling recess portion 12 are formed by machining both ends of the circular rod by means of a tool such as a gun drill.

However, in case of the piston rod 10 of the conventional vehicle height adjusting shock absorber, if the hollow portion 14 is long, eccentricity between an axial of the hollow portion 14 and an axial of the piston rod 10 occurs during the process of machining the hollow portion 14. Thus, the straightness of the hollow portion 14 is deteriorated and the machined inner surface of the hollow portion 14 is not smooth. Accordingly, friction and wear can occur between the hollow portion 14 and the pump tube, and if severe, the products can be deformed.

Further, it is difficult to remove chips generated in the hollow portion 14 when it is machined, which can clog the inner channel of the shock absorber after the machining.

In addition, since the piston rod 10 is machined from a solid rod, there are problems in that the increased working time is required and the manufacturing costs are increased.

### SUMMARY OF THE INVENTION

The present invention is conceived to solve the aforementioned problems in the prior art. An object of the present invention is to provide a piston rod of a vehicle height adjusting shock absorber, in which a member with a hollow portion formed therein, such as a pipe, is used in a machining process of the piston rod, thereby improving the degree of cleanness in the hollow portion of the piston rod, and easily managing its eccentricity to reduce inferior products, and a method of machining the piston rod.

According to an aspect of the present invention for achieving the object, there is provided a piston rod installed to a vehicle height adjusting shock absorber. The piston rod comprises a body portion having a hollow portion formed therein and both ends opened; a catching portion formed to be spaced apart by a predetermined distance inwardly from one end of the hollow portion; and a guide member inserted into the hollow portion from the other end thereof to plug the open hollow portion, the guide member being caught to the catching portion for the movement of the guide member to be constrained.

The piston rod may further comprise an O-ring installed to at least any one of the guide member and the hollow portion corresponding thereto to seal a gap therebetween. Further, a thread having a predetermined length may be formed on the one end of the hollow portion. Furthermore, the guide member may be formed with a step portion corresponding to an inner diameter of the catching portion.

In addition, according to another aspect of the present invention for achieving the object, there is provided a method of machining a piston rod installed to a vehicle height adjusting shock absorber. The method comprises the steps of preparing a body portion having a hollow portion formed therein and both ends opened; machining an inner surface of the hollow portion from one end thereof to form a catching portion to be spaced apart by a predetermined distance inwardly from the other end of the hollow portion; and contacting a guide member with the catching portion by inserting the guide member into the hollow portion from the open one end thereof after providing the guide member corresponding to the machined inner surface of the hollow portion.

The contacting step may comprise the step of installing an O-ring to at least any one of the guide member and the hollow portion corresponding thereto to seal a gap therebetween.

### BRIEF DESCRIPTION OF THE DRAWINGS

FIG. 1 is a sectional view of a part of a conventional piston rod;

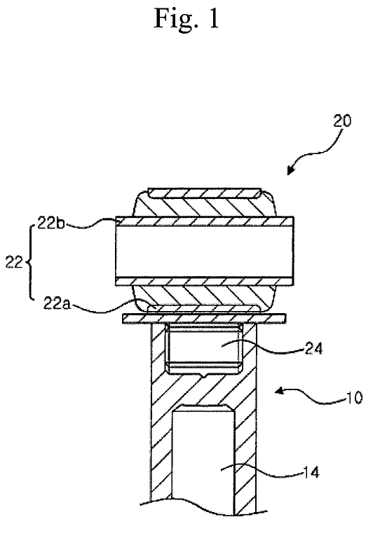

FIG. 2 is a sectional view showing the upper eye separated from the part of the conventional piston rod;

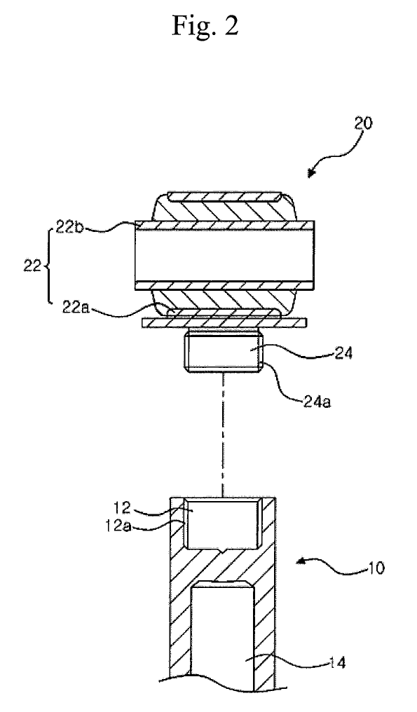

FIG. 3 is a sectional view of a vehicle height adjusting shock absorber having a piston rod according to the present invention; and

FIG. 4 is a sectional view showing the upper eye separated from a part of the piston rod according to the present invention.

### DETAILED DESCRIPTION OF EMBODIMENTS

Hereinafter, an embodiment according to the present invention will be described in detail with reference to the accompanying drawings.

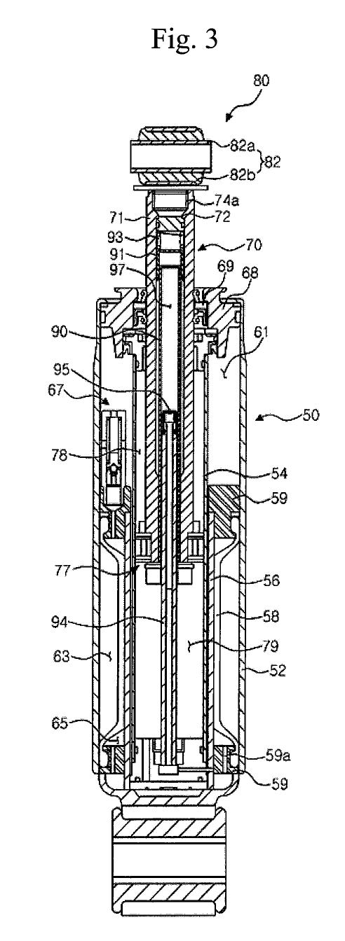

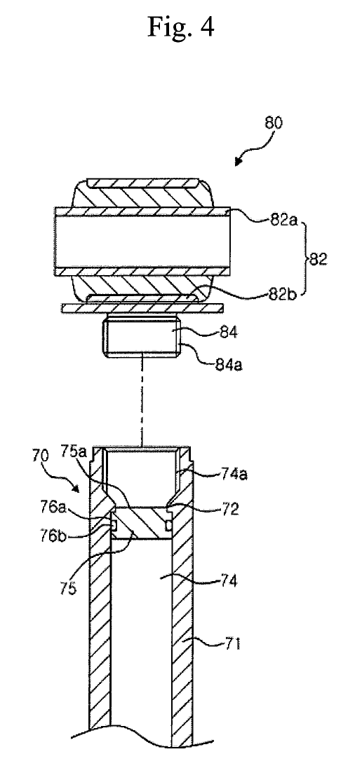

FIG. 3 is a sectional view of a vehicle height adjusting shock absorber having a piston rod according to the present invention, and FIG. 4 is a sectional view showing that an upper eye is separated from a part of the piston rod according to the present invention.

As shown in FIG. 3, a vehicle height adjusting shock absorber 50 according to the present invention includes a base shell 52, an inner tube 54 installed inside the base shell 52, an outer tube 56, and a blade 58. The outer tube 56 and the blade 58 are longitudinally installed between the base shell 52 and the inner tube 54.

The blade 58 is fixed by brackets 59 installed between the base shell 52 and the outer tube 56. Preferably, both ends of the blade 58 are shaped (e.g., bent) so as to contact the base shell 52 and define an enclosed space. In addition, the bracket 59 is formed with a vent 59a to allow the chambers separated by the bracket to connect with each other.

A space enclosed between the inner tube 54 and the base shell 52 defines a base chamber 61. A space enclosed by the blade 58 and the base shell 52 and a space enclosed by the blade 58 and the outer tube 56 respectively define a gas chamber 63 and a high pressure chamber 65. In addition, a relief valve 67 for maintaining the pressure in the high pressure chamber 65 is installed on a side of the outer tube 56.

In the meantime, a piston rod 70 is installed inside the inner tube 54 and a rod guide 68 and an oil seal 69 are installed in the upper end of the inner tube 54 to guide the movement of the piston rod 70.

A piston valve 77 is installed at an end of the piston rod 70 to divide the interior of the inner tube 54 into a rebound chamber 78 and a compression chamber 79 and to control the flow of fluid between the rebound chamber 78 and the compression chamber 79.

In the meantime, the piston rod 70 has a hollow pump tube 90 installed therein to adjust the height of the vehicle. A hollow pump rod 94 is inserted into the pump tube 90, so that a pump chamber 97 is defined in a space between the pump tube 90 and the pump rod 94. In addition, an inlet valve 95 is provided in the upper end of the pump rod 94, and an outlet valve 91 (opened and closed by the up and down operation of the piston rod) is provided in an upper end of the pump tube 90. The outlet valve 91 is supported at its upper portion by a spring 93 positioned thereon. When the spring 93 is compressed, the outlet valve 91 is opened.

To this end, as shown in FIG. 4, the piston rod 70 includes a body portion 71 in which a hollow portion 74 is formed in an axial direction, and both ends of the hollow portion 74 are open.

In addition, the body portion 71 is formed with a catching portion 72 which is spaced a predetermined distance inwardly from one end of the hollow portion 74. Preferably, the body portion 71 is a pipe, in which the hollow portion has the same inner diameter as the catching portion 72. The catching portion 72 in the hollow portion can be formed by machining the interior of the hollow portion of the body portion to the desired diameter. This creates the hollow portion 74.

Also, the guide member 75 is inserted into the hollow portion 74 to plug the open hollow portion 74. At this time, the guide member 75 is inserted from the other end of the hollow portion 74, and attached to the catching portion 72 to constrain the movement of the guide member 75.

In addition, the guide member 75 is formed with a step portion 75a corresponding to an inner diameter of the catching portion 72, whereby the body portion 71 and the guide member 75 are more securely coupled to each other. Also, a predetermined groove 76a is formed around the guide member 75, and an O-ring 76b fitted into the groove 76a to form a seal. Further, a thread 74a having a predetermined length is formed on the one end of the hollow portion 74, so that the coupling portion 84 of the upper eye 80 can be screwed into the hollow portion 74. The coupling portion 84 is formed with a thread 84a corresponding to the thread 74a of the hollow portion 74 to be engaged therewith. The upper eye 80 also includes a ring portion 82 having inner and outer rings 82a, 82b to be coupled with the vehicle body.

A method of machining the piston rod so configured will be described as follows.

First, there is provided the body portion 71, such as a pipe, having the hollow portion 74 formed therein. The inner surface of the hollow portion 74 is machined from the other end thereof so that the catching portion 72 is formed at the position spaced apart by the predetermined distance from the one end of the hollow portion 74.

Next, there is provided the guide member 75 having an outer diameter corresponding to an inner diameter of the hollow portion 74. At this time, the groove 76a having a predetermined size is formed in the outer peripheral portion of the guide member 75, and the O-ring 76b is coupled to the groove 76a.

The guide member 75 provided as above is pushed into the hollow portion 74 from the other end in order to plug the opening of the hollow portion 74. At this time, the guide member 75 is caught and thus fixed to the catching portion 72 formed in the hollow portion 74.

In the meantime, the coupling portion 84 of the upper eye 80 is screwed into the hollow portion 74.

As described above, in a case where a piston rod of a vehicle height adjusting shock absorber is made using a member of a pipe shape, there is no need for an additional machining work for forming a hollow portion in the piston rod. Accordingly, the shock absorber is easily manufactured, and thus the working speed is improved. In addition, since the hollow portion is machined by means of a tool such as a gun drill, the eccentricity is easily managed. Also, a degree of cleanness for a machined inner surface is improved, thereby improving quality of the products

The piston rod of a vehicle height adjusting shock absorber according to the present invention so configured and the method of machining the piston rod use a member with an interior being hollow as a piston rod. Therefore, the piston rod is easily manufactured due to the unnecessity of additionally machining the interior of the piston rod, thereby improving the manufacturing yield. Also, the eccentricity is easily managed in manufacturing the hollow portion, so that the linearity of the hollow portion can be improved. Further, a degree of cleanness for the machined inner surface can be improved, thus improving the quality of the product. Since the linearity of the hollow portion is improved as described above, the hollow portion does not interfere with a pump rod installed therein, thereby enhancing the durability and stability of the product.

Although the piston rod of a vehicle height adjusting shock absorber according to the present invention and the method of machining the piston rod are described with reference to the illustrated drawings, the present invention is not limited to the aforementioned embodiment and drawings. It will be apparent that those skilled in the art that they can make various modifications and changes thereto within the scope of the invention defined by the claims.

For example, although it has been described in the embodiment of the present invention that the O-ring for improving the sealing force of the piston rod is coupled to the groove formed in the guide member or upper eye, it is possible to form a groove in the hollow portion at the corresponding position when the guide member or upper eye is coupled and then to couple the O-ring thereto.

What is claimed is:

1. A piston rod installed to a vehicle height adjusting shock absorber, the piston rod comprising:
a body portion having a hollow portion, the hollow portion having first and second ends that are opened;
a catching portion formed to be spaced apart by a predetermined distance inwardly from the first end of the hollow portion; and
a guide member inserted into the hollow portion from the second end to plug the open hollow portion, the guide member being secured to the catching portion for the movement of the guide member to be constrained.

2. The piston rod as claimed in claim 1, further comprising an O-ring installed to at least any one of the guide member and the hollow portion corresponding thereto to seal a gap therebetween.

3. The piston rod as claimed in claim 1, wherein a thread having a predetermined length is formed on the first end of the hollow portion.

4. The piston rod as claimed in claim 1, wherein the guide member is formed with a step portion corresponding to an inner diameter of the catching portion.

5. The piston rod as claimed in claim 2, wherein the guide member is formed with a step portion corresponding to an inner diameter of the catching portion.

6. The piston rod as claimed in claim 3, wherein the guide member is formed with a step portion corresponding to an inner diameter of the catching portion.

7. A method of machining a piston rod installed to a vehicle height adjusting shock absorber, the method comprising:
preparing a body portion having a hollow portion formed, the hollow portion having first and second ends that are opened;
machining an inner surface of the hollow portion from the first end to form a catching portion to be spaced apart by a predetermined distance inwardly from the second end of the hollow portion; and
contacting a guide member with the catching portion by inserting the guide member into the hollow portion from the open one end thereof after providing the guide member corresponding to the machined inner surface of the hollow portion.

8. The method as claimed in claim 7, wherein the contacting step comprises the step of installing an O-ring to at least any one of the guide member and the hollow portion corresponding thereto to seal a gap therebetween.
